(19) United States
(12) Patent Application Publication
(10) Pub. No.: US 2025/0095924 A1
(43) Pub. Date: Mar. 20, 2025

(54) SOLID ELECTROLYTIC CAPACITOR

(71) Applicant: Panasonic Intellectual Property Management Co., Ltd., Osaka (JP)

(72) Inventors: TAKAHIRO YOSHII, Osaka (JP); KEI HIROTA, Okayama (JP); YOSHIHARU KATAOKA, Kyoto (JP)

(21) Appl. No.: 18/967,672

(22) Filed: Dec. 4, 2024

Related U.S. Application Data
(63) Continuation of application No. PCT/JP2023/022470, filed on Jun. 16, 2023.

(30) Foreign Application Priority Data
Jun. 30, 2022 (JP) 2022-105351

(51) Int. Cl. H01G 9/028; H01G 9/012; H01G 9/15

(52) U.S. Cl. CPC H01G 9/028; H01G 9/012; H01G 9/15

(57) ABSTRACT

A capacitor element includes an anode body including a first portion including a first end and a second portion including a second end, and a separation part disposed on a part positioned between the first end and the second end of the anode body. The conductive polymer layer includes an inner layer filled in at least a part of the porous part, and an outer layer positioned outside a principal surface of the anode body. The separation part includes an end A and an end B, the end B being positioned closer to the second end than the end A is. A filling proportion in a region C included in a cross section of a portion of the porous part from the end B to 0.05L is more than or equal to 46%, where L represents a length from the end B to an end of the cathode part at the second end side.

### BACKGROUND

### 1. Technical Field

The present disclosure relates to a solid electrolytic capacitor.

### 2. Description of the Related Art

A solid electrolytic capacitor includes a capacitor element, a resin exterior body or a case that seals the capacitor element, and an external electrode electrically connected with the capacitor element. The capacitor element includes an anode body, a dielectric layer formed on a surface of the anode body, and a cathode part that covers at least a part of the dielectric layer, for example. The cathode part includes a conductive polymer (for example, a conjugated polymer and a dopant) that covers at least a part of the dielectric layer. The conductive polymer is also referred to as a solid electrolyte. In the capacitor element, the anode body is divided into a portion covered with the cathode part (more specifically, a conductive polymer) (also referred to as cathode formation part in some cases) and a portion not covered with the cathode part.

Unexamined Japanese Patent Publication No. 2010-278423 discloses a solid electrolytic capacitor including an anode, a dielectric layer provided on a surface of the anode, a first conductive polymer layer provided on the dielectric layer, a second conductive polymer layer provided on the first conductive polymer layer, a third conductive polymer layer provided on the second conductive polymer layer, and a cathode layer provided on the third conductive polymer layer. Unexamined Japanese Patent Publication No. 2010-278423 proposes that the first conductive polymer layer is formed of a conductive polymer film formed by polymerizing pyrrole or a derivative thereof, the second conductive polymer layer is formed of a conductive polymer film formed by polymerizing thiophene or a derivative thereof, and the third conductive polymer layer is formed of a conductive polymer film formed by polymerizing pyrrole or a derivative thereof.

International Publication WO 2022/044939 discloses a solid electrolytic capacitor element including an anode body having a porous part on a surface thereof, a dielectric layer covering at least a part of the anode body, and a cathode part covering at least a part of the dielectric layer. International Publication WO 2022/044939 proposes that the cathode part includes a solid electrolyte layer covering at least part of the dielectric layer, the anode body includes a first anode body part formed with the solid electrolyte layer and a second anode body part not formed with the solid electrolyte layer, and the solid electrolyte layer includes a first solid electrolyte layer disposed in the porous part and a second solid electrolyte layer disposed outside the porous part, wherein when the first anode body part has a length L in a longitudinal direction of the first anode body part, the second solid electrolyte layer has a thickness of more than or equal to 1 μm in a region between an interface between the first anode body part and the second anode body part and a position a length of 0.05L away from the interface toward the first anode body part.

### SUMMARY

One aspect of the present disclosure relates to a solid electrolytic capacitor including at least one capacitor element. The at least one capacitor element includes: an anode body including a first portion including a first end and a second portion including a second end at a side opposite to the first end, the anode body including a porous part on a surface layer of the anode body; a dielectric layer covering at least a part of the anode body; a cathode part covering at least a part of the dielectric layer disposed on the second portion; and a separation part disposed on a part positioned between the first end and the second end of the anode body, the separation part insulating the first portion from the cathode part. The cathode part includes at least a conductive polymer layer covering at least the part of the dielectric layer. The conductive polymer layer includes an inner layer filled in at least a part of the porous part, and an outer layer positioned outside a principal surface of the anode body including the dielectric layer. The conductive polymer layer includes a conductive polymer. The separation part includes an end A and an end B, the end B being positioned closer to the second end than the end A is. A filling proportion in a region C included in a cross section of a portion of the porous part from the end B to 0.05L is more than or equal to 46%, where L represents a length from the end B to an end of the cathode part at a side close to the second end. The filling proportion is an area proportion of a portion other than voids in the region C.

A solid electrolytic capacitor having excellent durability can be provided.

### BRIEF DESCRIPTION OF THE DRAWING

FIG. 1 is a schematic sectional view illustrating a solid electrolytic capacitor according to an exemplary embodiment of the present disclosure.

### DETAILED DESCRIPTIONS OF EMBODIMENTS

Prior to the description of the exemplary embodiments, problems in the conventional technology will be briefly described.

Solid electrolytic capacitors are required to have excellent durability with which high electrostatic capacity can be obtained even when used for a long period of time or in a high-temperature environment.

Although novel features of the present invention are set forth in the appended claims, the present invention will be better understood by the following detailed description with the drawing, taken in conjunction with other objects and features of the present invention, both as to construction and content.

In the capacitor element, the anode body can be sectioned into a portion (second portion) in which a cathode part (in particular, a conductive polymer layer) is formed and a portion (first portion) in which the cathode part (in particular, the conductive polymer layer) is not formed. The anode body includes a first end and a second end opposite to the first end. The first portion includes the first end. The second portion includes the second end. In the capacitor element, an insulating separation part may be disposed on an appropriate position (for example, the boundary between the first portion and the cathode part and the vicinity thereof) between the first end and the second end of the anode body to ensure insulation between the first portion and the cathode part.

In the solid electrolytic capacitor, from the viewpoint of securing a high capacitance, a porous part is provided on at least a surface layer of the anode body to increase a surface area. The voids of the porous part are filled with a conductive polymer via a dielectric layer. From the viewpoint of securing a large surface area, the size of the void is preferably small. Meanwhile, it is difficult to highly fill the conductive polymer in the voids with small size. In particular, in the vicinity of the separation part in the second portion of the anode body, the filling proportion of the conductive polymer tends to be low. This is considered to be because the treatment liquid used for forming the conductive polymer is repelled by the insulating separation part, and the treatment liquid hardly enters the voids in the vicinity of the separation part.

In the solid electrolytic capacitor, when the filling proportion of the conductive polymer into the voids is low (in other words, the porosity is high) in the vicinity of the separation part, air enters from the first portion to the second portion through the remaining space of the porous part of this portion, or air enters from the vicinity of the boundary between the separation part and the second portion to the second portion. When the filling proportion of the conductive polymer is low, the mechanical strength of the porous part is also low. Thus, in the solid electrolytic capacitor, when stress is applied to the capacitor element because of molding or deformation due to voltage application, or thermal stress is applied to the capacitor element, the stress concentrates to a portion in the vicinity of the separation part of the cathode part to break the porous part, and thus an air entrance path may be formed. This also causes air to enter from the first portion to the second portion. When air enters the second portion of the anode body, the conductive polymer covering the second portion is oxidized and deteriorated, or dedoping (or decomposition of a dopant or the like) occurs, and thus conductivity of the conductive polymer decreases. Oxidative deterioration, dedoping, and the like of the conductive polymer are particularly remarkable when the solid electrolytic capacitor is used for a long period of time or at a high temperature (particularly when a state in which a voltage is applied continues or is repeated for a long time), and a decrease in electrostatic capacity is also remarkable. The electrostatic capacity can also be experimentally measured at the stage of the capacitor element before sealing with the exterior body. However, at the stage of the capacitor element, the stress applied to the vicinity of the separation part of the cathode part is very small as compared with the case of the solid electrolytic capacitor after sealing. Thus, even when an excellent result is obtained in the evaluation of the electrostatic capacity using the capacitor element, when the evaluation is actually performed using the solid electrolytic capacitor, the decrease in the electrostatic capacity may become remarkable as compared with the case of the capacitor element.

Considering the above, (Technology 1) a solid electrolytic capacitor according to the present disclosure includes at least one capacitor element, the at least one capacitor element including: an anode body including a first portion including a first end and a second portion including a second end on a side opposite to the first end, the anode body including a porous part on a surface layer of the anode body; a dielectric layer covering at least a part of the anode body; a cathode part covering at least a part of the dielectric layer disposed on the second portion; and a separation part disposed on a part positioned between the first end and the second end of the anode body, the separation part insulating the first portion from the cathode part. The cathode part includes at least a conductive polymer layer covering at least the part of the dielectric layer. The conductive polymer layer includes an inner layer filled in at least a part of the porous part, and an outer layer positioned outside a principal surface of the anode body including the dielectric layer, the conductive polymer layer including a conductive polymer. The separation part includes an end A and an end B, the end B being positioned closer to the second end than the end A is. A filling proportion in a region C included in a cross section of a portion of the porous part from the end B to 0.05L is more than or equal to 46%, where L represents a length from the end B to an end of the cathode part at a side close to the second end. The filling proportion is an area proportion of a portion other than voids in the region C.

By setting the filling proportion in region C in the vicinity of the separation part to more than or equal to 46%, the remaining space in region C is reduced. And the mechanical strength is enhanced. Since a portion having a high filling proportion in the vicinity of the separation part of the second portion serves as a barrier, entry of air from the first portion to the second portion of the anode body is reduced. Further, diffusion of air in the second portion and diffusion of air from the second portion to the conductive polymer layer are suppressed. Thus, even when the solid electrolytic capacitor is used for a long period of time or at a high temperature (in particular, even though a state in which a voltage is applied continues or is repeated for a long time), deterioration of the conductive polymer is suppressed, and high conductivity of the conductive polymer is maintained, whereby a decrease in electrostatic capacity is suppressed. Thus, excellent durability can be secured. In other words, high reliability of the solid electrolytic capacitor when the solid electrolytic capacitor is used for a long period or time or at a high temperature can be obtained. In the present disclosure, a decrease in electrostatic capacity of the solid electrolytic capacitor is suppressed even when a state in which a voltage is applied at a high temperature continues or is repeated for a long time, and thus high heat resistance (specifically, high durability against heat) of the solid electrolytic capacitor can be secured.

In the present specification, a direction parallel to a direction along the first end to the second end of the anode body is referred to as a length direction of the anode body. More specifically, the length direction of the anode body is a direction connecting the center of the end surface of the first end and the center of the end surface of the second end. The length direction of the cathode part and the length direction of the capacitor element are parallel to the length direction of the anode body. A direction perpendicular to the length direction and a thickness direction of the capacitor element is defined as a width direction of the capacitor element. When the lengths of the capacitor element in two directions perpendicular to the length direction of the capacitor element are compared, the shorter length is defined as the thickness direction, and the longer length is defined as the width direction. When the lengths of the capacitor element in two directions perpendicular to the length direction of the capacitor element are the same, either direction may be the width direction or the thickness direction. Length L from the end B of the separation part to the end of the cathode part at a side close to the second end is a length in a direction parallel to the length direction of the cathode.

The filling proportion is obtained for region C of a predetermined size in the vicinity of the center in the width direction of the capacitor element, the region C being in the vicinity of the separation part (specifically, a portion having a length of 0.05L from the end B of the separation part) of a cross section parallel to the length direction and the thickness direction. The vicinity of the center in the width direction refers to a region of ±0.1 W from the center in the width direction of the capacitor element when W represents the maximum width of the portion of the capacitor element where the cathode part is formed. Being parallel to the length direction of the capacitor element includes a case where the angle (acute angle) formed with the length direction is in a range of ±5°. Similarly, being parallel to the thickness direction of the capacitor element includes a case where the angle (acute angle) formed with the thickness direction is in the range of ±5°. A sample for measuring the filling proportion is prepared by cutting the solid electrolytic capacitor and exposing the cross section described above by ion milling. An image of the exposed cross section is taken by an optical microscope, the image is binarized, an area proportion of a portion other than voids to region C is obtained, and the area proportion is defined as the filling proportion (%). The binarization processing is performed by Otsu's binarization method, and the threshold value at which the difference is the largest when the color distribution in region C of the sectional image is sectioned into white and black is determined. With this threshold, the color distribution of region C is sectioned into white and black, and the proportion (%) of the white pixel to the entire pixels of region C is obtained. This proportion is obtained for region C of the porous part on both principal surface sides of the anode body in the cross section, and is averaged. The resulting average value is taken as the filling proportion (%). The proportion (%) of black pixels in the entire pixels of region C corresponds to the porosity. The total of the porosity and the filling proportion is 100%. Length L from the end B of the separation part to the end on the second end side of the cathode part is obtained from the sectional image described above. The magnification of the sectional image taken by the optical microscope is set to 10 times to 30 times (for example, 20 times). As the optical microscope, for example, a digital microscope “VHX-6000” series manufactured by KEYENCE CORPORATION is used.

(Technology 2) In (Technology 1), the region C is preferably a rectangular region having a first side and a second side orthogonal to the first side. The first side has a length in a range from 15 μm to 20 μm, inclusive. The second side has a length in a range from 20 μm to 25 μm, inclusive. In this case, the filling proportion can be accurately obtained.

The first side of region C may be parallel to the length direction or the thickness direction of the capacitor element but does not have to be parallel to the direction. The second side of region C may be parallel to the thickness direction or the length direction of the capacitor element but does not have to be parallel to the direction.

(Technology 3) In (Technology 1) or (Technology 2), the anode body includes a core part inside the anode body. The porous part may be formed integrally with a surface of the core part. And a shortest distance between the region C and the surface of the core part is preferably in a range from 0 μm to 5 μm, inclusive. In this case, it is advantageous in reducing variations in the measurement values of the filling proportion. The shortest distance between region C and the surface of the core part is the shortest distance between the average surface (in other words, the average bottom surface of the porous part) of the core part determined in the sectional image and region C. The filling proportion is determined by measuring and averaging regions C of the porous part formed on the surfaces on both sides of the core part. Preferably, the shortest distance between each region C and the average bottom surface of the porous part including each region C satisfies the above range.

(Technology 4) In any one of (Technology 1) to (Technology 3), the conductive polymer layer may include a conjugated polymer containing a monomer unit corresponding to at least one selected from the group consisting of a pyrrole compound, a thiophene compound, and an aniline compound.

Hereinafter, the solid electrolytic capacitor of the present disclosure will be described more specifically with reference to the drawing as necessary. At least one selected from the components described below can have any combination with at least one of the above (Technology 1) to (Technology 4) according to the solid electrolytic capacitor of the present disclosure, as long as the combination is technically possible.

### [Solid Electrolytic Capacitor]

### (Capacitor Element)

A capacitor element includes an anode body, a dielectric layer covering at least a part of the anode body, a cathode part covering at least a part of the dielectric layer in a second portion, and a separation part insulating the first portion and the cathode part.

### (Anode Body)

The anode body may include a valve metal, an alloy containing a valve metal, a compound containing a valve metal, or the like. The anode body may contain one of these materials, or may contain two or more of these materials in combination. Preferably available examples of the valve metal include aluminum, tantalum, niobium, and titanium.

The anode body includes a porous part at least on a surface layer.

The anode body having a porous surface layer is obtained by, for example, roughening a surface of a base material (sheet-like (for example, a foil shape or a plate shape) base material, etc.) containing a valve metal by etching or the like. The roughening can be performed by, for example, an etching treatment or the like. Such an anode body may include a core part and a porous part formed integrally with both surfaces of the core part. For one surface of the base material, the thickness of the porous part may be, for example, more than or equal to 30 μm. When the thickness of the porous part is more than or equal to 40 μm for one surface of the base material, it tends to be difficult to highly fill the conductive polymer in the vicinity of the separation part of the porous part. In the present disclosure, even when the thickness of the porous part is more than or equal to 40 μm, the conductive polymer can be highly filled in the vicinity of the separation part, and a high filling proportion can be secured. The thickness of the porous part may be less than or equal to 70 μm for one surface of the base material, although it depends on the thickness of the base material.

The anode body may be a porous molded body of particles containing a valve metal or a porous sintered body thereof. In each of the porous molded body and the porous sintered body, the entire anode body usually has a porous structure. Each of the molded body and the sintered body may have a sheet shape, a rectangular parallelepiped shape, a cube shape, a shape similar to these shapes, or the like.

The anode body includes a first portion including a first end and a second portion including a second end opposite to the first end. The first end and the second end are both ends in the length direction of the anode body. In the second portion, a cathode part (in particular, a conductive polymer layer) is formed on the second portion via the dielectric layer. Thus, the second portion may be referred to as a cathode formation part. In the first portion where the cathode part is not formed, a portion where the separation part is not formed may be referred to as an anode part (or an anode extraction part). The anode part may be connected with an anode lead terminal.

### (Dielectric Layer)

The dielectric layer is formed in such a manner as to cover at least a part of the anode body. The dielectric layer is an insulating layer that functions as a dielectric material. The dielectric layer is formed by anodizing the valve metal of the surface of the anode body by anodizing treatment or the like. In the dielectric layer formed on the surface of the anode body having the porous part, a surface of the dielectric layer has a fine uneven shape according to the shape of the surface of the porous part.

The dielectric layer may be formed of a material that functions as a dielectric layer. The dielectric layer includes, for example, an oxide of a valve metal as such a material. For example, when tantalum is used as the valve metal, the dielectric layer contains Ta₂O₅, and when aluminum is used as the valve metal, the dielectric layer contains Al₂O₃. However, the dielectric layer is not limited to these specific examples.

### (Cathode Part)

The cathode part is formed in such a manner as to cover at least a part of the dielectric layer in the second portion. The cathode part includes at least a conductive polymer layer (solid electrolyte layer) covering at least a part of the dielectric layer. The cathode part may include a conductive polymer layer and a cathode lead-out layer covering at least a part of the conductive polymer layer. Hereinafter, the conductive polymer layer and the cathode lead-out layer will be described.

### (Conductive Polymer Layer)

The conductive polymer layer includes a conductive polymer. The conductive polymer layer includes an inner layer filled in at least a part of the porous part, and an outer layer protruding from a principal surface of the anode body having the dielectric layer. A dielectric layer is formed on at least a part of the inner wall of the voids. The inner layer may be formed in such a manner as to adhere to the inner wall of the void via the dielectric layer. The principal surface of the anode body having the dielectric layer is an average surface positioned at each of both ends in the thickness direction (in other words, in the direction parallel to the stacking direction of the layers in the capacitor element) of the anode body in the sectional image for measuring the filling proportion. In the second portion, the conductive polymer layer may include an inner layer filled in the voids and an outer layer outside the side surface (an average surface positioned at both ends in the width direction of the anode body) or the end surface (an average surface positioned at an end in the length direction of the anode body) even on the side surface or the end surface other than the principal surface.

In the present disclosure, the filling proportion in region C included in the portion from end B of the separation part of the porous part to 0.05 L is more than or equal to 46%. In other words, the filling proportion is as high as more than or equal to 46% in the porous part in the vicinity of the separation part, which is originally difficult to have high filling proportion. As a result, entry of air from the anode part into the second portion is suppressed, and even when the solid electrolytic capacitor is used for a long period of time or at a high temperature in a state where a voltage is applied, deterioration of the conductive polymer is suppressed, high conductivity is maintained, and thus high capacitance can be maintained. The filling proportion may be more than or equal to 47%, or may be more than or equal to 47.4%. In these cases, the effect of maintaining a high capacitance is further enhanced, and higher durability can be secured. The filling proportion corresponds to the ratio of white pixels binarized by Otsu's binarization method as described above. The white pixels mainly correspond to the anode body, the conductive polymer layer (inner layer), and the dielectric layer. Thus, when the number of voids is small, the filling proportion tends to be high. Meanwhile, in the porous part of the second portion, a large number of voids are formed to increase the specific surface area, and thus a high capacitance can be obtained. Thus, region C included in the porous part of the second portion has a relatively high porosity at a stage before forming the conductive polymer layer. Hence, in the solid electrolytic capacitor, the fact that region C exhibits a high filling proportion of more than or equal to 46% means that region C is highly filled with the conductive polymer. The upper limit of the filling proportion is not particularly limited, but it is difficult to set the filling proportion to 100%, and the filling proportion is usually less than or equal to 70%.

The conductive polymer constituting the conductive polymer layer contains, for example, a conjugated polymer and a dopant. The conductive polymer may further contain an additive agent as necessary.

Examples of the conjugated polymer include known conjugated polymers used in solid electrolytic capacitors, such as x-conjugated polymers. Examples of the conjugated polymer include a polymer having polypyrrole, polythiophene, polyaniline, polyfuran, polyacetylene, polyphenylene, polyphenylene vinylene, polyacene, or polythiophene vinylene as a basic skeleton. Among these polymers, a polymer having polypyrrole, polythiophene, or polyaniline as a basic skeleton is preferable. The polymer is required to contain at least one monomer unit constituting the basic skeleton. The monomer unit also includes a monomer unit having a substituent. The polymer also includes a homopolymer, and a copolymer of two or more monomers. For example, polythiophene includes poly (3,4-ethylenedioxythiophene) and the like.

Among the conjugated polymers, a conjugated polymer containing a monomer unit corresponding to at least one selected from the group consisting of a pyrrole compound, a thiophene compound, and an aniline compound is preferable. Examples of the pyrrole compound include a compound having a pyrrole ring and capable of forming a repeated structure of a corresponding monomer unit. Examples of the thiophene compound include a compound having a thiophene ring and capable of forming a repeated structure of a corresponding monomer unit. These compounds can be linked at the 2-position and the 5-position of the pyrrole ring or the thiophene ring to form the repeated structure of the monomer unit. Examples of the aniline compound include a compound having a benzene ring and at least one (preferably one) amino group bonded to the benzene ring and capable of forming a repeated structure of a corresponding monomer unit. The aniline compound can be linked to, for example, an amino group at a CH group (a CH group constituting the benzene ring) moiety at the para-position with respect to the amino group to form the repeated structure of the monomer unit.

The pyrrole compound may have a substituent at at least one of the 3-position and the 4-position of the pyrrole ring, for example. The thiophene compound may have a substituent at at least one of the 3-position and the 4-position of the thiophene ring, for example. The substituent at the 3-position and the substituent at the 4-position may be linked to form a ring fused to a pyrrole ring or a thiophene ring. Examples of the pyrrole compound include pyrrole that may have a substituent at at least one of the 3-position and the 4-position. Examples of the thiophene compound include thiophene that may have a substituent at at least one of the 3-position and the 4-position and an alkylene dioxythiophene compound (C₂₋₄ alkylenedioxythiophene compounds such as ethylenedioxythiophene compounds, and the like). The alkylene dioxythiophene compound also includes those having a substituent in an alkylene group moiety. Examples of the aniline compound include an aniline optionally having a substituent at at least one of the ortho-position and the para-position with respect to an amino group.

The substituent is preferably, but is not limited to, an alkyl group (C₁₋₄ alkyl groups such as methyl group and ethyl group, and the like), an alkoxy group (C₁₋₄ alkoxy groups such as methoxy group and ethoxy group, and the like), a hydroxy group, a hydroxyalkyl group (hydroxy C₁₋₄ alkyl groups such as a hydroxymethyl group, and the like), or the like. When each of the pyrrole compound, the thiophene compound, and the aniline compound has two or more substituents, the respective substituents may be identical to or different from each other.

A conjugated polymer containing at least a monomer unit corresponding to pyrrole, or a conjugated polymer (such as PEDOT) containing at least a monomer unit corresponding to a 3,4-ethylenedioxythiophene compound (such as 3,4-ethylenedioxythiophene (EDOT)) may be used. The conjugated polymer including at least a monomer unit corresponding to pyrrole may include only a monomer unit corresponding to pyrrole, or may include a monomer unit corresponding to a pyrrole compound other than pyrrole (such as pyrrole having a substituent) in addition to the monomer unit. The conjugated polymer including at least a monomer unit corresponding to EDOT may include only a monomer unit corresponding to EDOT, or may include a monomer unit corresponding to a thiophene compound other than EDOT in addition to the monomer unit.

The conductive polymer layer may contain one conjugated polymer, or may contain two or more conjugated polymers in combination.

The weight-average molecular weight (Mw) of the conjugated polymer is not particularly limited, and is, for example, in a range from 1,000 to 1,000,000, inclusive.

The weight-average molecular weight (Mw) and the number-average molecular weight (Mn) herein are values in terms of polystyrene measured by gel permeation chromatography (GPC). Usually, GPC is measured using a polystyrene gel column, and water and methanol (volume ratio 8:2) as a mobile phase.

Examples of the dopant include at least one selected from the group consisting of an anion and a polyanion.

Examples of the anion include, but are not particularly limited to, a sulfate ion, a nitrate ion, a phosphate ion, a borate ion, an organic sulfonate ion, and a carboxylate ion. Examples of the dopant that generates sulfonate ions include benzenesulfonic acid, p-toluenesulfonic acid, and naphthalenesulfonic acid.

Examples of the polyanion include a polymer anion. The conductive polymer layer may contain, for example, a conjugated polymer including a monomer unit corresponding to a thiophene compound and a polymer anion.

Examples of the polymer anion include a polymer having a plurality of anionic groups. Examples of such a polymer include a polymer including a monomer unit having an anionic group. Examples of the anionic group include a sulfo group and a carboxy group. The polymer anion preferably has at least a sulfo group.

In the conductive polymer layer, the anionic group of the dopant may be contained in a free form, an anion form, or a salt form, or may be contained in a form bonded to or interacting with the conjugated polymer. All of these forms herein may be simply referred to as “anionic group”, “sulfo group”, “carboxy group”, or the like.

Examples of the polymer anion having a sulfo group include a polymer-type polysulfonic acid. Specific examples of the polymer anion include polyvinylsulfonic acid, polystyrenesulfonic acid (including a copolymer and a substitution product having a substituent), polyallylsulfonic acid, polyacrylsulfonic acid, polymethacrylsulfonic acid, poly (2-acrylamide-2-methylpropanesulfonic acid), polyisoprenesulfonic acid, polyestersulfonic acid (aromatic polyester sulfonic acid or the like), and phenolsulfonic acid novolac resin. However, the polymer anion is not limited to these specific examples.

The content of the dopant contained in the conductive polymer layer may be, for example, in a range from 10 parts by mass to 1000 parts by mass, inclusive, in a range from 20 parts by mass to 500 parts by mass, inclusive, or in a range from 50 parts by mass to 200 parts by mass, inclusive, with respect to 100 parts by mass of the conjugated polymer.

In the conductive polymer layer, the inner layer and the outer layer may be a single layer, or may be layers having different compositions. Each of the conductive polymer layer, the inner layer, and the outer layer may be a single layer or may be composed of a plurality of layers. When the conductive polymer layer, the inner layer, or the outer layer is composed of a plurality of layers, the conductive polymers contained in the layers may be the same or different. The dopants included in the respective layers may be the same or different.

A layer for improving adhesion or the like may be interposed between the dielectric layer and the conductive polymer layer.

Examples of the additive agent include a known additive agent (for example, a coupling agent and a silane compound) to be added to the conductive polymer layer, a known conductive material other than the conductive polymer, and a water-soluble polymer. The conductive polymer layer (or each layer constituting the conductive polymer layer) may contain one of these additive agents, or may contain a combination of two or more thereof. When the conductive polymer layer, the inner layer, or the outer layer is composed of a plurality of layers, the additive agents contained in the respective layers may be the same or different.

Examples of the conductive material as the additive agent include at least one selected from the group consisting of conductive inorganic materials such as manganese dioxide and TCNQ complex salts.

The conductive polymer layer is usually formed by using a liquid composition (a solution, a liquid dispersion, or the like) containing a conductive polymer or performing in-situ polymerization (chemical polymerization, electrolytic polymerization, or the like) using a liquid composition (polymerization liquid) containing a precursor of a conjugated polymer and a dopant. In the present disclosure, from the viewpoint of highly filling the region in the vicinity of the separation part of the second portion with the conductive polymer to form a dense inner layer, at least a part of the inner layer (when the inner layer is formed of a plurality of layers, at least the innermost layer) is preferably formed by electrolytic polymerization. Controlling polymerization conditions and the like through electrolytic polymerization, the porous part can be highly filled with the conductive polymer even in the vicinity of the separation part, and the filling proportion can be increased. The entire conductive polymer layer may be formed through electrolytic polymerization. In addition, a portion other than the outer layer or the innermost layer of the conductive polymer layer may be formed through chemical polymerization, formed using a liquid composition containing a conductive polymer, or formed by a combination thereof.

The electrolytic polymerization can be performed by a three-electrode method. For example, on the surface of the dielectric layer, at least a part of the inner layer may be formed by electrolytically polymerizing a precursor of the conjugated polymer in the presence of a dopant by a three-electrode method. For example, electrolytic polymerization is performed in a state where the second portion of an anode body having a dielectric layer formed on a surface thereof is immersed in a liquid composition (polymerization liquid) containing the precursor of the conjugated polymer and the dopant. In the three-electrode method, electrolytic polymerization is performed using an anode body, a counter electrode, and a reference electrode. In the three-electrode method, since the polymerization reaction can be controlled with high accuracy as compared with a two-electrode method using an anode body and a counter electrode, a dense conductive polymer layer is easily formed, and the filling proportion of the porous part can be increased even in the vicinity of the separation part. In addition, the filling proportion of the porous part is increased not only in the vicinity of the separation part but also in the entire second portion, and the entrance of air in the entire cathode part can be reduced as compared with the conventional case. Thus, degradation of the conductive polymer is suppressed in the whole conductive polymer layer, and durability of the solid electrolytic capacitor can be improved.

Examples of the precursor of the conjugated polymer include a raw material monomer of the conjugated polymer, and an oligomer and a prepolymer in which a plurality of molecular chains of the raw material monomer are linked. One precursor may be used, or two or more precursors may be used in combination. From the viewpoint of easily obtaining higher orientation of the conjugated polymer, at least one selected from the group consisting of a monomer and an oligomer (in particular, monomer) is preferably used as the precursor.

The liquid composition used for electrolytic polymerization usually contains a solvent. Examples of the solvent include water, an organic solvent, and a mixed solvent of water and an organic solvent (such as a water-soluble organic solvent). When another conductive material, an additive agent, and the like are used, they may be added to the liquid composition.

The liquid composition (polymerization liquid) may contain an oxidizing agent as necessary. The oxidizing agent may be applied to the anode body before or after the liquid composition is brought into contact with the anode body on which the dielectric layer is formed. Examples of such an oxidizing agent include a compound capable of generating Fe³⁺ (such as a ferric sulfate), a persulfate (such as a sodium persulfate or an ammonium persulfate), and a hydrogen peroxide. One oxidizing agent may be used alone, or two or more oxidizing agents may be used in combination.

The electrolytic polymerization in a three-electrode method is performed in a state where the anode body on which the dielectric layer is formed, a counter electrode, and a reference electrode are immersed in a liquid composition (polymerization liquid). As the counter electrode, for example, a Ti electrode is used, but the counter electrode is not limited to this. As the reference electrode, it is preferable to use a silver/silver chloride electrode (Ag/Ag⁺).

The electrolytic polymerization may be performed at a polymerization voltage in a range from 0.6 V to 1.5 V, inclusive, for example. The polymerization voltage is preferably more than or equal to 0.6 V and less than 1 V, more preferably in a range from 0.7 V to 0.95 V, inclusive, and may be in a range from 0.75 V to 0.9 V, inclusive, from the viewpoint of easily filling the voids of the porous part with the conductive polymer at a high level. Performing electrolytic polymerization in a three-electrode method at such a polymerization voltage makes it possible to precisely control the polymerization reaction in the voids. Thus, in the voids, a polymer chain of the conjugated polymer can be grown in the presence of the dopant, and the voids can be highly filled with the conductive polymer. In addition, since the polymerization can proceed slowly, the orientation and crystallinity of the conjugated polymer can be further enhanced, a relatively high doping rate can be obtained, and relatively high conductivity can be easily secured. The polymerization voltage is a potential of the anode body with respect to the reference electrode (silver/silver chloride electrode (Ag/Ag⁺)).

The electrolytic polymerization may be performed at a temperature in a range from 5° C. to 60° C., inclusive, or in a range from 15° C. to 35° C., inclusive, for example.

From the viewpoint of highly filling the voids with the conductive polymer, it is preferable to form a precoat layer containing a conductive material on the surface of the dielectric layer prior to electrolytic polymerization. The precoat layer may be formed using a liquid composition containing a conductive polymer. In the liquid composition to be used for forming the precoat layer, it is preferable that the conductive polymer has a small particle size, or the conductive polymer is dissolved. The concentration of the conductive polymer in the liquid composition is preferably relatively low. The dry solid content concentration of the liquid composition used for electrolytic polymerization is, for example, less than or equal to 1.2 mass %.

When the liquid composition is a liquid dispersion containing a conductive polymer (such as a conductive polymer and a dopant), particles of the conductive polymer contained in the liquid dispersion have an average primary particle size of, for example, less than or equal to 100 nm, and may be less than or equal to 60 nm. In a liquid composition (such as a liquid dispersion) containing a conductive polymer, which is used to form a conductive polymer layer constituting a cathode part, particles of the conductive polymer usually have an average primary particle size of more than or equal to 200 nm and a dry solid concentration of more than or equal to 2 mass %.

It is also preferable that the liquid composition is a solution. The liquid composition in a solution state contains, for example, a self-doped conductive polymer as the conductive polymer. In the self-doped conductive polymer, an acid group such as a sulfo group is introduced into a polymer chain, and is easily dissolved in a solvent, and thus a liquid composition in a solution state is easily obtained. Thus, the liquid composition easily penetrates into the voids, and polymerization tends to more uniformly occur in the voids. For example, the precoat layer may be formed by using a polyaniline compound (soluble polyaniline compound or the like) into which an acid group such as a sulfo group is introduced.

The conjugated polymer (or the polymer chain of the conductive polymer) of the precoat layer and the conjugated polymer formed by the electrolytic polymerization may be the same or different in type. The dopant of the precoat layer and the dopant for use in the electrolytic polymerization may be the same or different.

From the viewpoint of easily securing a higher filling proportion, the weight-average molecular weight (Mw) of the conductive polymer (or the conjugated polymer) forming the precoat layer is preferably in a range from 1000 to 1,000,000, inclusive, and may be in a range from 1000 to 850,000, inclusive.

From the viewpoint of easily securing a higher filling proportion, the molecular weight distribution (=weight-average molecular weight/number-average molecular weight=Mw/Mn) of the conductive polymer (or the conjugated polymer) forming the precoat layer is preferably less than or equal to 3.2, may be less than or equal to 3, less than or equal to 2.9, or less than or equal to 2.85. Mw/Mn is 1 or more.

### (Cathode Lead-Out Layer)

The cathode lead-out layer is required to include at least a first layer that is in contact with the conductive polymer layer and covers at least a part of the conductive polymer layer. The cathode lead-out layer may include the first layer and a second layer covering the first layer. Examples of the first layer include a layer containing conductive particles, and metal foil. Examples of the conductive particles include at least one selected from conductive carbon and metal powder. For example, the cathode lead-out layer may be formed of a layer containing conductive carbon (also referred to as a carbon layer) as the first layer and a layer containing metal powder or metal foil as the second layer. When the metal foil is used as the first layer, the metal foil may constitute the cathode lead-out layer.

Examples of the conductive carbon include graphite (artificial graphite, natural graphite, and the like).

The layer containing metal powder as the second layer can be formed by stacking a composition containing metal powder on a surface of the first layer, for example. Examples of such a second layer include a metal particle-containing layer (for example, a metal-paste layer such as a silver-paste layer) formed by using a composition containing metal powder such as silver particles and a resin (binder resin). Although a thermoplastic resin may be used for the resin, use of a thermosetting resin such as an imide resin or an epoxy resin is preferable.

When a metal foil is used as the first layer, the type of the metal is not particularly limited. The metal foil is preferably formed using a valve metal such as aluminum, tantalum, or niobium, or an alloy containing the valve metal. The metal foil has a surface that may be roughened as necessary. The surface of the metal foil may be provided with an anodization film, and may be provided with a film of metal (dissimilar metal) different from the metal constituting the metal foil, or a nonmetal film. Examples of the dissimilar metal and the nonmetal include metal such as titanium, and nonmetal such as carbon (conductive carbon and the like).

The first layer may be formed of a film of the dissimilar metal or the nonmetal (for example, conductive carbon), and the second layer may be formed of the metal foil described above.

### (Separator)

When the metal foil is used for the cathode lead-out layer, a separator may be disposed between the metal foil and the anode body (anode foil or the like). The separator is not particularly limited. For example, it is possible to use a nonwoven fabric including fibers of cellulose, polyethylene terephthalate, vinylon, or polyamide (for example, aliphatic polyamide or aromatic polyamide such as aramid).

### (Separation Part)

The separation part is positioned between the first end and the second end. The separation part is provided in such a manner as to insulate the first portion (more specifically, the anode part) from the cathode part. The separation part is provided with a predetermined width, for example, in a portion where the porous part between the first end and the second end of the anode body is formed. The separation part may be formed, for example, at an end of the first portion that is located close to the second portion. Meanwhile, the cathode part may be formed on the surface of the separation part at an end of the separation part close to the second end portion. In other words, the separation part may be provided from the end of the first portion at a side close to the second portion to the end of the second portion at a side close to the first portion. From the viewpoint of more reliably securing insulation between the first portion and the cathode part, it is preferable that the separation part is not provided on the second portion.

In the region where the separation part of the anode body is formed, the porous part may be compressed in the thickness direction of the anode body. In the region where the separation part of the anode body is formed, the porous part may be removed as necessary. In these cases, it is possible to further suppress the entrance of air from the anode part side to the second portion side through the voids in the vicinity of the separation part.

The separation part includes an insulating material, for example, an insulating resin material or a cured product thereof. Examples of the resin material include thermoplastic resins (or compositions thereof) and curable resin materials (curable resin compositions, etc.). The separation part may contain an insulating material in a state of being filled in the voids of the porous part, may contain an insulating material in a state of being disposed on the surface of the porous part, or may contain both of them. For example, the separation part may include a cured product of an insulating material formed in the voids of the porous part and a cured product of an insulating material formed on the principal surface of the anode body with the dielectric layer interposed between the separation part and the cured product. The separation part may contain a sheet-like insulating material such as an insulating tape attached on the principal surface of the anode body. The separation part may include a cured product of an insulating material formed in the voids of the porous part, and a sheet-like insulating material such as an insulating tape attached to the principal surface of the anode body.

Examples of the resin material include a curable resin (polyimide-based resin, silicon resin, phenol resin, urea resin, melamine resin, unsaturated polyester, furan resin, polyurethane, silicon resin (silicone), curable acrylic resin, epoxy resin, or the like), a photoresist, and a thermoplastic resin (for example, polyamide, polyamideimide, thermoplastic polyimide, polyphenylene sulfone-based resin, polyether sulfone-based resin, cyanate ester resin, and fluororesin). The resin material may contain one of these resins, or may contain a combination of two or more thereof. The resin material includes not only a resin that is a polymer but also a resin precursor (monomers, oligomers, prepolymers, or the like) depending on the type of the resin. The curable resin material may be a one-component curable resin material or a two-component curable resin material. In addition to the resin, the resin composition may contain at least one selected from the group consisting of a curing agent, a curing accelerator, a polymerization initiator, a catalyst, a coupling agent, and the like. The resin composition may contain a known additive agent to be used for forming the separation part of the capacitor element, as necessary. Examples of such additive agent include a flame retardant, a filler, a colorant, a mold release agent, and an inorganic ion scavenger.

The separation part can be formed, for example, by a step including a sub-step of filling the pores of the porous part with a treatment liquid containing the resin composition and a solvent, and curing the resin composition. In the production of the capacitor element, prior to the step of forming the separation part (third step), a first step of preparing an anode body having a porous part on a surface layer and a second step of forming a dielectric layer on a surface of the porous part are performed. For the first step and the second step, description for the anode body and the dielectric layer can be referred to. Then, after the separation part is formed, a cathode part including a conductive polymer layer and the like is formed on the second portion of the anode body via a dielectric layer (fourth step).

The separation part is formed of an insulating material, and easily repels a liquid composition (polymerization liquid) for electrolytic polymerization. Thus, it is difficult to highly fill the voids with the conductive polymer in the porous part in the vicinity of the separation part. In the present disclosure, the conductive polymer can be highly filled in the voids even in the vicinity of the separation part, and the filling proportion of region C can be increased by adjusting the polymerization conditions (in particular, the polymerization voltage) of the electrolytic polymerization, the conditions of the precoating, and the like. Thus, the entry of air into the capacitor element is suppressed, and the deterioration of the conductive polymer is suppressed, which can suppress a decrease in capacitance when the solid electrolytic capacitor is used for a long period of time or used at a high temperature in a state where a voltage is applied. Thus, excellent durability of the solid electrolytic capacitor can be secured.

### (Others)

The solid electrolytic capacitor includes at least one capacitor element. The solid electrolytic capacitor may be a wound type, or may be either a chip type or a stacked type. For example, the solid electrolytic capacitor may include two or more stacked capacitor elements. The solid electrolytic capacitor may include two or more wound-type capacitor elements. The capacitor element may have a configuration selected according to the type of the solid electrolytic capacitor.

The capacitor element includes, for example, the cathode lead-out layer to which one end of a cathode lead terminal is electrically connected. For example, a conductive adhesive is applied to the cathode lead-out layer, and the cathode lead terminal is joined to the cathode lead-out layer via the conductive adhesive. For example, one end of an anode lead terminal is electrically connected to the anode part of the anode body. The anode lead terminal and the cathode lead terminal each have the other end that is drawn out from a resin exterior body or a case. The other end of each terminal exposed from the resin exterior body or the case is used for, for example, solder connection to a substrate on which the solid electrolytic capacitor is to be mounted.

The capacitor element is sealed using a resin exterior body or a case. For example, the capacitor element and a material resin (for example, uncured thermosetting resin and filler) of the exterior body may be housed in a mold, and the capacitor element may be sealed with the resin exterior body by a transfer molding method, a compression molding method, or the like. At this time, the other end side portions of the anode lead terminal connected to the anode lead and the cathode lead terminal drawn out from the capacitor element are exposed from the mold. The solid electrolytic capacitor may be formed by accommodating the capacitor element in a bottomed case such that the other end side portions of the anode lead terminal and the cathode lead terminal are positioned on the opening side of the bottomed case, and sealing the opening of the bottomed case with a sealing body.

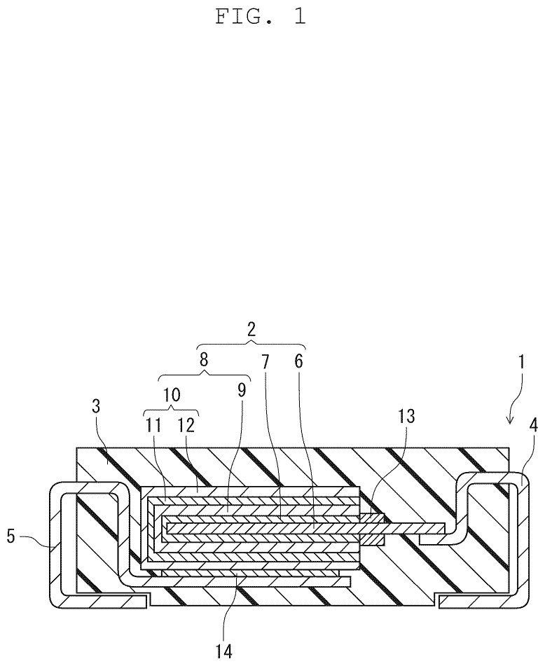

FIG. 1 is a sectional view schematically illustrating a structure of a solid electrolytic capacitor according to an exemplary embodiment of the present disclosure. The solid electrolytic capacitor of the present disclosure is not limited only to the following exemplary embodiment. The components of the following exemplary embodiment may have any combination with at least any one of the above (1) to (4) according to the solid electrolytic capacitor of the present disclosure.

As illustrated in FIG. 1, solid electrolytic capacitor 1 includes capacitor element 2, resin exterior body 3 that seals capacitor element 2, and anode lead terminal 4 and cathode lead terminal 5 that are each at least partially exposed to an outside of resin exterior body 3. Anode lead terminal 4 and cathode lead terminal 5 can be made of metal such as copper or a copper alloy, for example. Resin exterior body 3 has a substantially rectangular parallelepiped outer shape, and solid electrolytic capacitor 1 also has a substantially rectangular parallelepiped outer shape.

Capacitor element 2 includes anode foil 6 made of Al foil, dielectric layer 7 covering anode foil 6, and cathode part 8 covering dielectric layer 7. Cathode part 8 includes conductive polymer layer 9 covering dielectric layer 7, and cathode lead-out layer 10 covering conductive polymer layer 9. Anode foil 6 has a porous part formed on both surface layers by etching or the like. Conductive polymer layer 9 includes, at anode foil 6 including dielectric layer 7, an inner layer filled in at least a part of the porous part, and an outer layer positioned outside a principal surface of anode foil 6.

Anode foil 6 includes a region (second portion) facing cathode part 8 and a region (first portion) not facing cathode part 8. The first portion includes one end (first end) in a length direction of anode foil 6, and the second portion includes a second end opposite to the first end. Separation part 13 that insulates the first portion from cathode part 8 is formed between the first end and the second end of anode foil 6. In the illustrated example, separation part 13 is formed in such a manner as to cover a surface of anode foil 6 in a band shape, and it regulates contact between cathode part 8 and the first portion of anode foil 6. In the vicinity of end B on the second end portion side of the separation part 13, the porous part has a filling proportion of more than or equal to 46% in a predetermined region.

In the region (first portion) not facing cathode part 8 of anode foil 6, a portion (anode part) on the first end side is electrically connected to anode lead terminal 4 by welding. Cathode lead terminal 5 is electrically connected to cathode part 8 via adhesive layer 14 formed of a conductive adhesive.

### EXAMPLES

Hereinafter, the solid electrolytic capacitor according to the present disclosure will be specifically described with reference to Examples and Comparative Examples, but the solid electrolytic capacitor according to the present disclosure is not limited to only the following Examples.

### <<Solid Electrolytic Capacitors A1 to A3 and B1 to B2>>

Solid electrolytic capacitors were produced and evaluated in the following manner.

### (1) Preparation of Anode Foil

Both surfaces of an aluminum foil (thickness: 130 μm) were roughened by etching, whereby an anode foil having a porous part on both surface layers was produced. The obtained anode foil had porous parts formed on the surface layers on both principal surface, and a core part sandwiched between the porous parts. The thickness of the porous part at each principal surface was 50 μm, and the thickness of the core part was 30 μm.

### (2) Formation of Dielectric Layer

The second portion (cathode formation part) including the second end of the anode foil was immersed in an anodizing solution, and a DC voltage of 70 V was applied for 20 minutes, whereby a dielectric layer containing aluminum oxide was formed.

### (3) Formation of Conductive Polymer Layer

A separation part was formed in a predetermined region between the first end and the second end (more specifically, a predetermined region including an end of the first portion at a side close to the second portion) of the anode foil on which the dielectric layer was formed. The anode foil on which the separation part was formed was precoated by immersing the anode foil in a liquid composition containing polyaniline sulfonic acid as a conductive material, taking out the anode foil, and drying the anode foil. The weight-average molecular weight (Mw) and molecular weight distribution (Mw/Mn) of the polyaniline sulfonic acid used in the precoating are shown in Table 1.

A polymerization liquid containing pyrrole (monomer of a conjugated polymer), naphthalenesulfonic acid (dopant), and water was prepared. Using the obtained polymerization liquid, electrolytic polymerization was performed by a three-electrode method. More specifically, the precoated anode foil, a counter electrode, and a reference electrode (silver/silver chloride reference electrode) were immersed in the polymerization liquid. A voltage was applied to the anode foil so that the potential of the anode foil with respect to the reference electrode had the value of the polymerization voltage shown in Table 1, and electrolytic polymerization was performed at 25° C., whereby a conductive polymer layer was formed.

### (4) Formation of Cathode Lead-Out Layer

The anode foil obtained in the above (3) step was immersed in a dispersion liquid in which graphite particles were dispersed in water, taken out from the dispersion liquid, and then dried, whereby a first layer (carbon layer) was formed on the surface of the conductive polymer layer. Drying was performed at a temperature in a range from 130° C. to 180° C. inclusive for 10 minutes to 30 minutes.

Next, a silver paste containing silver particles and a binder resin (epoxy resin) was applied onto a surface of the first layer, and heated at a temperature in a range from 150° C. to 200° C. inclusive for 10 minutes to 60 minutes to cure the binder resin, whereby a second layer (metal particle-containing layer) was formed. A cathode lead-out layer composed of the first layer (carbon layer) and the second layer (metal particle-containing layer) was thus formed, and a cathode part composed of the conductive polymer layer and the cathode lead-out layer was formed.

A capacitor element was thus produced.

### (5) Assembly of Solid Electrolytic Capacitor

The cathode part of the capacitor element obtained in the above (4) step was joined to one end of a cathode lead terminal with an adhesive layer made of a conductive adhesive interposed between the cathode part and the one end of the cathode lead terminal. One end of an anode lead terminal was joined to a region close to the first end of the first portion of the anode foil protruding from the capacitor element by laser welding.

Subsequently, a resin exterior body formed of an insulating resin was formed around the capacitor element by molding. At this time, the other end of the anode lead terminal and the other end of the cathode lead terminal were drawn out from the resin exterior body.

A solid electrolytic capacitor was thus completed. In the same manner as described above, 20 solid electrolytic capacitors were produced in total.

### [Evaluation]

The following evaluations were performed using the solid electrolytic capacitors.

### (a) Durability (Reliability) Test

The initial electrostatic capacity (μF) of each solid electrolytic capacitor at a frequency of 120 Hz was measured using an LCR meter for 4-terminal measurement under an environment of 20° C. Then, an average value (C₀) of the 20 solid electrolytic capacitors was obtained.

Next, each solid electrolytic capacitor was allowed to stand at 145° C. for 400 hours in a state where a voltage of 2 V was applied to the solid electrolytic capacitor. After the standing, the electrostatic capacity was measured in the same manner as in the initial electrostatic capacity under an environment of 20° C., and an average value (C₁) of the 20 solid electrolytic capacitors was obtained. The C₁/C₀ ratio was obtained. And the solid electrolytic capacitor satisfying C₁/C₀<0.8 was determined as a defective product having low durability (reliability). The durability (reliability) was evaluated by the ratio (%) of the number of defective products to 20.

### (b) Filling Proportion in Region C

Using each solid electrolytic capacitor, an optical microscope image (magnification: 20 times) of a cross section parallel to the length direction and the thickness direction in the vicinity of the center in the width direction of the capacitor element was binarized by Otsu's binarization method, and the area proportion (filling proportion (%)) occupied by the region other than the voids in region C was obtained by the procedure described above.

Evaluation results are shown in Table 1. Solid electrolytic capacitors A1 to A3 are Examples, and solid electrolytic capacitors B1 to B2 are Comparative Examples.

TABLE 1

| | | Poly- | Filling | | |
|---|---|---|---|---|---|
| Precoat | | merization | proportion | Defective | |
| Mw | Mw/Mn | potential (V) | (%) | rate (%) | |
| A1 | 4.13 × 10⁴ | 2.22 | 0.90 | 47.5 | 0 |
| A2 | 3.24 × 10³ | 1.34 | 0.75 | 47.4 | 0 |
| A3 | 8.25 × 10⁵ | 2.85 | 0.80 | 48.4 | 0 |
| B1 | 1.73 × 10² | 3.72 | 1.00 | 45.2 | 15 |
| B2 | 3.24 × 10⁶ | 4.52 | 1.00 | 43.7 | 25 |

As shown in Table 1, when the filling proportion of region C is more than or equal to 46%, the defective rate is 0, and excellent durability (reliability) is obtained (solid electrolytic capacitors A1 to A3). On the other hand, when the filling proportion of region C is less than 46%, the defective rate becomes remarkably higher than that of solid electrolytic capacitors A1 to A3 (comparison between solid electrolytic capacitors A1 to A3 and solid electrolytic capacitors B1 to B2). As the filling proportion decreases, the defective rate tends to increase (comparison between solid electrolytic capacitors A1 to A3 and solid electrolytic capacitors B1 to B2).

Although the present invention has been described in terms of presently preferred exemplary embodiments, such disclosure should not be construed in a limiting manner. Various modifications and alterations will undoubtedly become apparent to the person of ordinary skill in the art to which the present invention belongs upon reading the above disclosure. Thus, the appended scope of claims should be construed to cover all modifications and alterations without departing from the true spirit and scope of the present invention.

The present disclosure can secure high heat resistance of a solid electrolytic capacitor. The solid electrolytic capacitor of the present disclosure can be used in various applications where excellent durability (reliability) or high heat resistance is required. However, the application of the solid electrolytic capacitor is not limited to these.

What is claimed is:

1. A solid electrolytic capacitor comprising at least one capacitor element,
the at least one capacitor element including:
an anode body including a first portion including a first end and a second portion including a second end at a side opposite to the first end, the anode body including a porous part on a surface layer of the anode body;
a dielectric layer covering at least a part of the anode body;
a cathode part covering at least a part of the dielectric layer disposed on the second portion; and
a separation part disposed on a part positioned between the first end and the second end of the anode body, the separation part insulating the first portion from the cathode part,
wherein:
the cathode part includes at least a conductive polymer layer covering at least the part of the dielectric layer,
the conductive polymer layer includes an inner layer filled in at least a part of the porous part, and an outer layer positioned outside a principal surface of the anode body including the dielectric layer, the conductive polymer layer including a conductive polymer,
the separation part includes an end A and an end B, the end B being positioned closer to the second end than the end A is,
a filling proportion in a region C included in a cross section of a portion of the porous part from the end B to 0.05L is more than or equal to 46%, where L represents a length from the end B to an end of the cathode part at a side close to the second end, and
the filling proportion is an area proportion of a portion other than voids in the region C.

2. The solid electrolytic capacitor according to claim 1, wherein the region C is a rectangular region having a first side and a second side orthogonal to the first side, the first side having a length in a range from 15 μm to 20 μm, inclusive, the second side having a length in a range from 20 μm to 25 μm, inclusive.

3. The solid electrolytic capacitor according to claim 1, wherein:
the anode body includes a core part inside the anode body,
the porous part is formed integrally with a surface of the core part, and
a shortest distance between the region C and the surface of the core part is in a range from 0 μm to 5 μm, inclusive.

4. The solid electrolytic capacitor according to claim 1, wherein the conductive polymer layer includes a conjugated polymer containing a monomer unit corresponding to at least one selected from the group consisting of a pyrrole compound, a thiophene compound, and an aniline compound.
